(19) United States
(12) Patent Application Publication
(10) Pub. No.: US 2021/0147270 A1
(43) Pub. Date: May 20, 2021

(54) NITROGEN TREATMENT METHOD

(71) Applicant: HITACHI, LTD., Tokyo (JP)

(72) Inventors: Makiko UDAGAWA, Tokyo (JP); Shoko MIYAMAE, Tokyo (JP); Yuuya KIMURA, Tokyo (JP); Shinichi YOSHIKAWA, Tokyo (JP)

(21) Appl. No.: 17/046,347

(22) PCT Filed: Mar. 5, 2019
(86) PCT No.: PCT/JP2019/008707

§ 371 Date: Oct. 9, 2020

(30) Foreign Application Priority Data
Apr. 11, 2018 (JP) 2018-076198

(51) Int. Cl. C02F 3/34; C02F 3/10; C02F 11/18; C02F 1/66

(52) U.S. Cl. CPC C02F 3/341; C02F 3/10; C02F 2101/166; C02F 1/66; C02F 11/185

(57) ABSTRACT

The present invention provides a nitrogen treatment method which can suppress the production of nitrate nitrogen to stabilize the concentration of nitrite nitrogen in a nitritation treatment in which ammoniacal nitrogen is biologically oxidized to produce the nitrite nitrogen. A nitrogen treatment method includes a nitrification treatment step of producing nitrite nitrogen by oxidizing ammoniacal nitrogen contained in water to be treated, using microbial sludge, wherein: a volume load of the ammoniacal nitrogen in the nitrification treatment step is set to a high load of 0.3 kg-N/m³·day or more and 5 kg-N/m³·day or less; and in the nitrification treatment step, at least one of a treatment of adjusting a pH of the water to be treated to pH 8 or more and pH 10 or less and a treatment of applying an inactivating operation for sterilizing microorganisms or causing bacteriostasis to the microbial sludge is performed.

### TECHNICAL FIELD

The present invention relates to a nitrogen treatment method for wastewater, and particularly relates to a nitrogen treatment method for biologically oxidizing ammoniacal nitrogen contained in wastewater to produce nitrite nitrogen.

### BACKGROUND ART

Wastewater containing nitrogen components is a key factor in causing eutrophication in closed water areas to cause water pollution. Therefore, a nitrogen treatment is performed by decomposing and removing nitrogen components contained in wastewater using microorganisms in some sewage treatment facilities and wastewater treatment facilities.

Conventionally, as a method for biologically subjecting wastewater containing nitrogen components to a nitrogen treatment, a nitrification denitrification treatment performed by a combination of a nitrification treatment and a denitrification treatment has been widely used. In the nitrification denitrification treatment, ammoniacal nitrogen contained in water to be treated is oxidized up to nitrate nitrogen by nitrifying bacteria, and the nitrate nitrogen is then converted into molecular nitrogen by denitrifying bacteria.

Meanwhile, the anaerobic ammonium oxidation (anammox) method has been recently developed to be practically usable. The anaerobic ammonium oxidation method is a method in which ammonium and nitrous acid are co-denitrified with anaerobic ammonium oxidizing bacteria. According to the anaerobic ammonium oxidation method, ammoniacal nitrogen and nitrite nitrogen in water to be treated are converted into molecular nitrogen and slight nitrate nitrogen by an anaerobic ammonium oxidation reaction.

The anaerobic ammonium oxidation reaction is a reaction in which autotrophy anaerobic ammonium oxidizing bacteria use ammonium as a hydrogen donor, which makes it unnecessary to supply an organic substance such as methanol, whereby the operating cost is advantageously suppressed. The anaerobic ammonium oxidation reaction makes it unnecessary to oxidize nitrite nitrogen to nitrate nitrogen, which provides reduced cost required for aeration. The anaerobic ammonium oxidizing bacteria have a high denitrification rate, while having a small growth amount, whereby the equipment scale can be reduced without the treatment efficiency being impaired, which advantageously provides a reduced amount of excess sludges.

Wastewater containing nitrogen components contains ammoniacal nitrogen in many cases. Meanwhile, in the anaerobic ammonium oxidation reaction, ammonium ions react with nitrite ions at a rate of about 1:1.3. Therefore, in the anaerobic ammonium oxidation method, nitritation is preliminarily performed so that a part of ammoniacal nitrogen is oxidized to nitrite nitrogen before the anaerobic ammonium oxidation reaction.

A nitrogen treatment system by the anaerobic ammonium oxidation method is categorized in two techniques. One is a single-tank technique which uses a single tank configured to perform nitritation and anaerobic ammonium oxidation. The other is a two-tank technique which uses an ammonia oxidation tank configured to perform the nitritation and an anaerobic ammonium oxidation reactor configured to perform the anaerobic ammonium oxidation.

Examples of the single-tank technique include a CANON method performed under aeration limited to a low oxygen concentration, an OLAND method performed under a condition limited to a low oxygen concentration, an SNAP method performed by growing anaerobic ammonium oxidizing bacteria in a carrier in which a nitrification bacterial group is adhesively immobilized, and an SBR method performed by a semi-batch system.

Examples of the two-tank technique include a one-pass method in which an entire amount of water to be treated is introduced into an ammonia oxidation tank to partially nitrite-oxidize a part of ammoniacal nitrogen, and

a by-pass method in which a part of water to be treated is introduced into an ammonia oxidation tank to nitrite-oxidize all of ammoniacal nitrogen, and the remained part of the water to be treated is diverted, and then merged.

Generally, microbial sludge containing a nitrification bacterial group used for nitritation. The nitrification bacterial group is generally a mixture of ammonia oxidizing bacteria (AOB) which oxidize ammoniacal nitrogen to nitrite nitrogen and nitrogen oxidizing bacteria (NOB) which oxidize nitrite nitrogen to nitrate nitrogen. Therefore, both the treatment systems are required to control the progress of the nitritation so that the oxidation of ammoniacal nitrogen is limited to partial oxidation up to nitrite nitrogen, and the operation is performed while the production amount and rate of the nitrite nitrogen are kept.

Conventionally, it is known that the operation of nitritation using a nitrification bacterial group is not easily continued while the concentration of nitrite nitrogen is stably kept. In normal water quality, nitrite oxidizing bacteria is apt to grow. Thus, in many cases, nitrite nitrogen produced by the ammonia oxidizing bacteria is rapidly oxidized to nitrate nitrogen, and therefore, it is difficult to control the oxidation of the ammoniacal nitrogen within the partial oxidation stopping to the nitrite nitrogen. Therefore, various techniques have been investigated to control the concentration of the nitrite nitrogen.

For example, Patent Literature 1 discloses a nitrification method in which the aeration flow rate of a nitrification tank is adjusted to control the nitrification to be nitritation. Patent Literature 2 discloses a method for nitrifying wastewater containing ammoniacal nitrogen. In this method, a nitrification tank is divided to two tanks of first and second nitrification tanks, and the nitrification conditions of the first nitrification tank are maintained so that water to be treated in the first nitrification tank has a free ammonia concentration than or equal to a concentration to inhibit the activity of nitrite oxidizing bacteria.

Patent Literature 3 discloses a method for manufacturing a nitritation carrier which preferentially accumulates ammonia oxidizing bacteria. Sludge is inclusively immobilized with a monomer or a prepolymer for immobilizing bacteria, and the resultant material is then heated at 30° C. to 80° C. Patent Literature 3 discloses another method in which a monomer or a prepolymer for immobilizing bacteria is heated in the presence of sludge at 30° C. to 80° C. for 1 hour or more for polymerization.

As disclosed in Non-Patent Literature 1, examples of a technique of controlling the concentration of nitrite nitrogen include a technique of measuring a total nitrogen concentration or an ammoniacal nitrogen concentration to control a dissolved oxygen concentration based on a nitrite rate based on the total nitrogen concentration or the ammoniacal nitrogen concentration. In Non-Patent Literature 1, the total nitrogen concentration and the ammoniacal nitrogen concentration are measured in a sensing tank provided on a downstream side of a treatment tank for nitrite-oxidizing.

### CITATION LIST

### Patent Literatures

Patent Literature 1: JP 5292659 B2
Patent Literature 2: JP 2005-131452 A
Patent Literature 3: JP 3788601 B2

### Non-Patent Literature

Non-Patent Literature 1: ISAKA, K. et al. Novel autotrophic nitrogen removal system using gel entrapment technology, Bioresource technology, 2011, 102, p. 7720-7726

### SUMMARY OF INVENTION

### Technical Problem

As disclosed in Patent Literature 1 and Patent Literature 2, there is a technique of adjusting the dissolved oxygen concentration or the ammoniacal nitrogen concentration to adjust the concentration of the nitrite nitrogen. However, the technique of adjusting only the aeration flow rate as in Patent Literature 1 and the technique of adjusting only the free ammonia concentration as in Patent Literature 2 have problems of low control responsiveness and accuracy. When the dissolved oxygen concentration is temporarily or locally high, or the free ammonia concentration is temporarily or locally low, the activity of the nitrite oxidizing bacteria becomes strong, so that the accumulation of the nitrate nitrogen extremely proceeds for a normal retention time, which makes it difficult to stably maintain the concentration the nitrite nitrogen.

As disclosed in Non-Patent Literature 1, the technique of controlling the nitrification rate by only the dissolved oxygen concentration requires high technical capabilities in order to control the aeration flow rate, and may be unable to cope with fluctuations in the activity of the microbial sludge. Once the activity of the nitrite oxidizing bacteria becomes strong, the accumulation of the nitrate nitrogen may proceed. Therefore, the technique depending on only the dissolved oxygen concentration is not sufficient to stabilize the concentration of the nitrite nitrogen.

Therefore, it is an object of the present invention to provide a nitrogen treatment method which can suppress the production of nitrate nitrogen and stabilize the concentration of nitrite nitrogen in a nitritation treatment in which ammoniacal nitrogen is biologically oxidized to produce the nitrite nitrogen.

### Solution to Problem

In order to solve the above problems, a nitrogen treatment method according to the present invention is a nitrogen treatment method for biologically treating a nitrogen component contained in wastewater, the nitrogen treatment method comprising a nitrification treatment step of producing nitrite nitrogen by oxidizing ammoniacal nitrogen contained in water to be treated, using microbial sludge, wherein: a volume load of the ammoniacal nitrogen in the nitrification treatment step is set to a high load of 0.3 kg-N/m³·day or more and 5 kg-N/m³·day or less; and in the nitrification treatment step, at least one of a treatment of adjusting a pH of the water to be treated to pH 8 or more and pH 10 or less and a treatment of applying an inactivating operation for sterilizing microorganisms or causing bacteriostasis to the microbial sludge is performed.

### Advantageous Effects of Invention

The present invention can suppress the production of nitrate nitrogen and stabilize the concentration of nitrite nitrogen in a nitritation treatment in which ammoniacal nitrogen is biologically oxidized to produce the nitrite nitrogen.

### BRIEF DESCRIPTION OF DRAWINGS

FIG. 1 is a schematic diagram showing an example of a wastewater treatment device used for a nitrogen treatment.

FIG. 2 is a schematic diagram showing another example of a wastewater treatment device used for a nitrogen treatment.

### DESCRIPTION OF EMBODIMENTS

Hereinafter, a nitrogen treatment method according to an embodiment of the present invention will be described with reference to the drawings. In the following respective drawings, constitutions which are in common have the same reference characters, and the repetitive description thereof will be omitted.

A nitrogen treatment method according to the present embodiment relates to a method for biologically treating a nitrogen component contained in wastewater (water to be treated) for denitrification. This nitrogen treatment method includes at least a nitritation treatment step of producing nitrite nitrogen by oxidizing ammoniacal nitrogen contained in water to be treated, using microbial sludge.

In the nitrogen treatment method according to the present embodiment, the load of the ammoniacal nitrogen in the nitrification treatment step is increased, and at least one of a treatment of adjusting the pH of the water to be treated and a treatment of applying an inactivating operation to the microbial sludge is performed. According to the high load, the treatment of adjusting the pH, and the treatment of applying the inactivating operation, the production of the nitrate nitrogen by nitrite oxidizing bacteria is suppressed, and the concentration of the nitrite nitrogen is also stabilized.

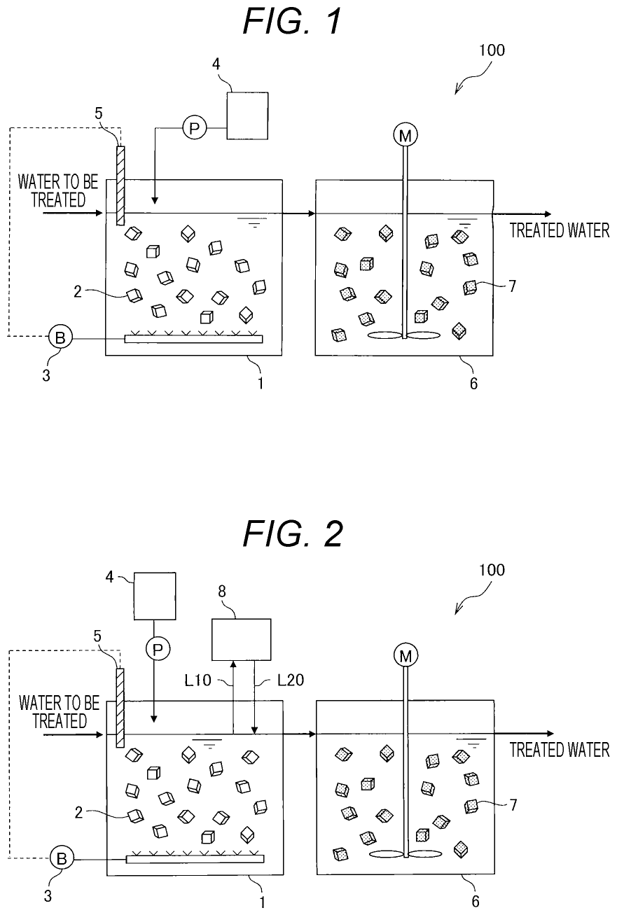

FIG. 1 is a schematic diagram showing an example of a wastewater treatment device used for a nitrogen treatment.

The nitrogen treatment method according to the present embodiment can be conducted in a wastewater treatment device 100 as shown in FIG. 1. The wastewater treatment device 100 shown in FIG. 1 includes an ammonia oxidation tank 1, microbial sludge 2, an air diffuser 3, a pH adjusting device 4, a dissolved oxygen (DO) sensor 5, an anaerobic ammonium oxidation reactor 6, and microbial sludge 7.

The wastewater treatment device 100 is a device which subjects wastewater containing a nitrogen component (water to be treated) to a nitrogen treatment according to an anaerobic ammonium oxidation method, and is a two-tank device which performs nitritation and anaerobic ammonium oxidation in separate reactors. In the wastewater treatment device 100, in order to suppress the production of nitrate nitrogen, the treatment of adjusting the pH of the water to be treated can be performed during the operation of the ammonia oxidation tank 1.

Examples of the water to be treated include wastewater discharged from factories such as a sewage treatment facility, a semiconductor plant, a metal refinery, a pharmaceutical manufacturing facility, and a stockbreeding facility. The wastewater may contain nutrient salts of phosphorus, carbon, and heavy metals and the like in addition to ammoniacal nitrogen. The wastewater may be subjected to an activated sludge treatment, a denitrification treatment with heterotrophic denitrifying bacteria, and a dephosphorization treatment and the like before the nitrification treatment performed in the ammonia oxidation tank 1.

The ammonia oxidation tank 1 is a treatment tank for performing a nitritation treatment of oxidizing ammoniacal nitrogen contained in water to be treated to nitrite nitrogen. The ammonia oxidation tank 1 holds the microbial sludge 2 for biologically treating the water to be treated. The ammonia oxidation tank 1 includes an air diffuser 3 for aerating the water to be treated and a dissolved oxygen sensor 5, and the pH adjusting device 4 is connected to the ammonia oxidation tank 1 through a pipe.

The microbial sludge 2 is sludge containing bacteria and protists, and contains a nitrification bacterial group. The nitrification bacterial group is generally a mixture of ammonia oxidizing bacteria (AOB) classified in Nitrosomonas, Nitrosococcus, Nitrosospira, and Nitrosolobus and the like, and nitrite oxidizing bacteria (NOB) classified in Nitrobactor, Nitrospina, Nitrococcus, and Nitrospira and the like.

The microbial sludge 2 is immobilized on a fluidized bed carrier in FIG. 1. The microbial sludge used in the ammonia oxidation tank 1 may be in any one of a state of being inclusively immobilized in a carrier, being inclusively immobilized on a surface of the carrier, being adhesively immobilized to the carrier, forming granules via self-granulation, and floating sludge which floats in water. The immobilized microbial sludge may be used in any one of an immobilized bed, a fluidized bed, and a moving bed.

Examples of the material of the carrier which can be used include appropriate materials such as mono(meth)acrylates, di(meth)acrylates, tri(meth)acrylates, tetra(meth)acrylates, urethane(meth)acrylates, epoxy(meth)acrylates, polyvinyl alcohol, vinylon, polyethylene glycol, polypropylene glycol, acrylamide, polyethylene, polypropylene, ethylene vinyl acetate copolymers, polyvinyl chloride, polyamides such as aramid and nylon, polyester, rayon, glass, and activated carbon.

The shape of the carrier may be an appropriate shape such as a cubic shape, a rectangular parallelepiped shape, a plate shape, a spherical shape, a disk shape, a cylindrical shape, a porous shape, a sponge shape, a fibrous shape, a cloth shape, a coin shape, a lotus root shape, or a chrysanthemum shape. The size of the carrier is not particularly limited, and may be, for example, 3 mm square.

The air diffuser 3 includes, for example, a diffuser and a diffusion pipe which produce bubbles, a blower which supplies air, a compressor which compresses air, and an air pipe which sends air from the blower to the diffuser and the diffusion pipe, and the like. The aeration flow rate of the water to be treated may be controlled to be constant, or may be variably controlled so as to provide an intended nitrification rate of interest depending on the concentration of the ammoniacal nitrogen and the concentration of the nitrite nitrogen and the like. However, in the present embodiment, the treatment of increasing the load of the ammoniacal nitrogen and stabilizing the production amount of the nitrite nitrogen is performed, which makes it unnecessary to precisely control the aeration flow rate.

The pH adjusting device 4 is provided to adjust the pH of the water to be treated which is subjected to a nitrification treatment in the ammonia oxidation tank 1. The pH adjusting device 4 includes, for example, a pH adjusting agent tank which stores a pH adjusting agent, and a chemical injection pump which supplies the pH adjusting agent to the ammonia oxidation tank 1, and the like. As the pH adjusting agent, for example, alkaline pH adjusting agents such as sodium hydrogen carbonate or sodium hydroxide can be used. When the pH of the water to be treated is adjusted to an alkaline side, a free ammonia concentration increases, so that the activity of the nitrite oxidizing bacteria is suppressed.

The dissolved oxygen sensor 5 measures the dissolved oxygen concentration of the water to be treated which is retained in the ammonia oxidation tank 1. Generally, the dissolved oxygen concentration of the water to be treated which is subjected to a nitrification treatment is controlled within a range of 0.5 mg/L or more and 4.0 mg/L or less, and adjusted so that the nitritation has a nitrification rate of interest.

The anaerobic ammonium oxidation reactor 6 is a treatment tank in which the ammoniacal nitrogen and nitrite nitrogen contained in the water to be treated are co-denitrized by an anaerobic ammonium oxidation reaction. The anaerobic ammonium oxidation reactor 6 holds the microbial sludge 7 containing anaerobic ammonium oxidizing bacteria in order to biologically treat the water to be treated. The anaerobic ammonium oxidation reactor 6 may include a stirring device for stirring the water to be treated and a pH adjusting device for supplying the pH adjusting agent to the water to be treated.

The microbial sludge 7 is immobilized to the fluidized bed carrier in FIG. 1. The microbial sludge 7 may be used in any one of a state of being inclusively immobilized in a carrier, being inclusively immobilized on a surface of the carrier, being adhesively immobilized to the carrier, forming granules via self-granulation, and floating sludge which floats in water. The immobilized microbial sludge may be used in any one of an immobilized bed, a fluidized bed, and a moving bed.

The shape, material, and size of the carrier in the anaerobic ammonium oxidation reactor 6 may be the same as those of the carrier in the ammonia oxidation tank 1. The anaerobic ammonium oxidation reactor 6 may be a gas lift type reactor in which water to be treated is circulated by an oxygen-free gas, an upward flow sludge bed type reactor in which granules are formed by the upward flow of water to be treated, or an immobilized bed type reactor using a filler for a carrier or the like.

Next, an example of a nitrogen treatment method according to the present embodiment will be specifically described with reference to the nitrogen treatment in the wastewater treatment device 100.

The nitrogen treatment by the anaerobic ammonium oxidation method can be performed by a method including a nitrification treatment step of oxidizing ammoniacal nitrogen contained in water to be treated, using microbial sludge to produce nitrite nitrogen, and an anaerobic ammonium oxidation treatment step of converting the ammoniacal nitrogen and the nitrite nitrogen contained in the water to be treated which is treated in the nitrification treatment step into molecular nitrogen according to an anaerobic ammonium oxidation reaction.

The water to be treated which is treated in the anaerobic ammonium oxidation treatment step is required to be preliminarily nitrite-oxidized until the ratio of the ammoniacal nitrogen to the nitrite nitrogen as a substrate for anaerobic ammonium oxidizing bacteria is around 1:1.3. The nitrate nitrogen produced by the nitrite oxidizing bacteria in the ammonia oxidation tank 1 does not serve as the substrate for the anaerobic ammonium oxidizing bacteria, whereby the water to be treated flowing into the anaerobic ammonium oxidation reactor 6 preferably has a low nitrate nitrogen concentration.

However, in the nitrification treatment step, under normal water quality and treatment conditions, the activity of the nitrite oxidizing bacteria tends to be stronger than that of the ammonia oxidizing bacteria due to differences in growth rate and sensitivity and the like. When the activity of the nitrite oxidizing bacteria is strong, the nitrite nitrogen converted by the ammonia oxidizing bacteria is quickly oxidized to the nitrate nitrogen, so that the ratio of the ammoniacal nitrogen to the nitrite nitrogen is unstable in the water to be treated flowing out from the ammonia oxidation tank 1. In such a case, the anaerobic ammonium oxidation is also unstable, and a final nitrogen removal rate is low.

Therefore, in the nitrogen treatment method according to the present embodiment, the load of the ammoniacal nitrogen in the nitrification treatment step is increased as compared to a conventional treatment, and in the nitrification treatment step, a treatment of adjusting the pH of the water to be treated is performed to suppress the production of the nitrate nitrogen.

From the viewpoint of avoiding the inhibition of nitrification activity and anaerobic ammonium oxidation activity, the total nitrogen concentration of the water to be treated and the concentration of the ammoniacal nitrogen are preferably 1 mg/L or more and 1000 mg/L or less. From the viewpoint of maximizing an effect provided by suppressing the nitrate nitrogen, a low concentration range which originally makes it difficult to achieve a high nitrogen removal rate is more preferable. Specifically, the total nitrogen concentration of the water to be treated and the concentration of the ammoniacal nitrogen are more preferably 10 mg/L or more and 150 mg/L or less.

When the total nitrogen concentration and the concentration of the ammoniacal nitrogen are high, the water to be treated can be preliminarily diluted with treated water or the like which has been subjected to an anaerobic ammonium oxidation treatment before the nitrification treatment step. At the time of startup which makes it necessary to acclimatize the microbial sludge, first, diluted water to be treated is caused to flow in, and the total nitrogen concentration and the concentration of the ammoniacal nitrogen are then gradually increased, whereby the water to be treated can be fed.

The volume load of the ammoniacal nitrogen in the nitrification treatment step is set to a high load of 0.3 kg-N/m³·day or more and 5 kg-N/m³·day or less. A general nitrification treatment is performed under a condition that the volume load of the ammoniacal nitrogen is 1 kg-N/m³·day or less, and is often designed to have a low load of about 0.1 to 0.2 kg-N/m³·day for a stable nitrogen treatment at a high nitrogen removal rate. In contrast, when the volume load is increased, the activity of the nitrification bacterial group in contact with the water to be treated is inhibited by high concentration ammonium. At this time, the activity of the nitrite oxidizing bacteria is significantly lower than that of the ammonia oxidizing bacteria, whereby the production of the nitrate nitrogen can be suppressed.

The volume load of the ammoniacal nitrogen in the nitrification treatment step may be 1 kg-N/m³·day or more and 5 kg-N/m³·day or less. When a sufficient nitrification rate is obtained, such a high load further reduces the activity of the nitrite oxidizing bacteria. This makes it possible to more reliably suppress the production of the nitrate nitrogen to stabilize the nitritation treatment.

As the method for increasing the volume load of the ammoniacal nitrogen, for example, a method for shortening a hydrologic retention time by providing a small volume of the ammonia oxidation tank 1, and a method for shortening a hydrologic retention time by increasing the flow rate of water to be treated, to be introduced into the ammonia oxidation tank 1, and the like can be used. When the volume load is increased, the nitrification rate required for the microbial sludge 2 can be obtained by a method for immobilizing the microbial sludge 2 at a high density, and a method for accumulating nitrifying bacteria at a high concentration, and the like.

When a microbial carrier is used in the ammonia oxidation tank 1, the carrier load of the ammoniacal nitrogen in the nitrification treatment step is set to a high load of 3 kg-N/m³-carrier·day or more and 100 kg-N/m³-carrier·day or less. When the carrier load is increased, the activity of the immobilized nitrification bacterial group is inhibited by high concentration ammonium. At this time, the activity of the nitrite oxidizing bacteria is significantly lower than that of the ammonia oxidizing bacteria, whereby the production of the nitrate nitrogen can be suppressed even when the microbial carrier is used.

The carrier load of the ammoniacal nitrogen in the nitrification treatment step may be 40 kg-N/m³-carrier·day or more and 100 kg-N/m³-carrier·day or less. When a sufficient nitrification rate is obtained, such a high load further reduces the activity of the nitrite oxidizing bacteria, whereby the production of the nitrate nitrogen can be more reliably suppressed. In addition to the cases of inclusive immobilization and adhesive immobilization, the (carrier) load of the ammoniacal nitrogen is preferably increased in the case of granules via self-granulation as with the case of the carrier.

As the method for increasing the carrier load of the ammoniacal nitrogen, for example, a method for shortening a hydrologic retention time by providing a small volume of the ammonia oxidation tank 1, a method for shortening a hydrologic retention time by increasing the flow rate of water to be treated, to be introduced into the ammonia oxidation tank 1, a method for reducing the amount of the carrier charged into the ammonia oxidation tank 1, and a method for reducing the amount of immobilized microorganisms held per carrier, and the like can be used. When the carrier load is increased, a nitrification rate required for the microbial sludge 2 can be obtained by a method for immobilizing the microbial sludge 2 at a high density, and a method for accumulating nitrifying bacteria at a high concentration, and the like.

The nitrification treatment step is performed under an aerobic condition in the ammonia oxidation tank 1 which holds the nitrification bacterial group while an alkali is added or the pH is adjusted, as necessary. The water temperature of the water to be treated is preferably 10° C. or higher and 40° C. or lower. The pH of the water to be treated is preferably at least pH 6 or more and pH 10 or less. The pH of the water to be treated decreases toward an acidic side as the nitrite oxidization of the ammoniacal nitrogen proceeds.

A treatment of adjusting the pH is performed by adjusting the pH of the water to be treated to pH 8 or more and pH 10 or less while the water to be treated is subjected to a nitrification treatment. For example, the pH of the water to be treated may be adjusted to a predetermined value on an alkaline side of pH 8 or more and pH 10 or less when the pH of the water to be treated is less than pH 8, or less than a predetermined value of pH 8 or more.

In a general nitrification treatment, near-neutral water to be treated is often treated without pH adjustment. In contrast, when the pH of the water to be treated is adjusted to an alkaline side, the free ammonia concentration increases, whereby the activity of the nitrification bacterial group is inhibited. At this time, the activity of the nitrite oxidizing bacteria is significantly lower than the activity of the ammonia oxidizing bacteria, whereby the nitrite nitrogen can be produced while the production of the nitrate nitrogen is suppressed. When the pH is 10 or less, the activity of the ammonia oxidizing bacteria is not extremely inhibited, whereby high ammonia oxidizing activity can be maintained.

In the treatment of adjusting the pH, the pH of the water to be treated is more preferably adjusted to pH 8.5 or higher and pH 9.5 or lower, and still more preferably adjusted to pH 8.7 or higher and pH 9.3 or lower. As the pH is higher (pH 8.5 or higher), the activity of the nitrite oxidizing bacteria is more reliably inhibited, whereby the production of the nitrate nitrogen can be suppressed as a minute amount to provide a more stable nitritation treatment. As the pH is lower (pH 9.5 or lower), the activity of the ammonia oxidizing bacteria is less likely to decrease, whereby high ammonia oxidizing activity can be obtained.

The treatment of adjusting the pH may be continuously or intermittently performed during the nitrification treatment of the water to be treated. The continuous adjustment makes it difficult for the pH of the water to be treated to decrease to an acidic side, whereby the activity of the nitrite oxidizing bacteria can be continuously suppressed during the nitrification treatment. When the adjustment is intermittently performed, the frequency and the amount of addition of the pH adjusting agent can be reduced, whereby cost required for the pH adjustment can be suppressed.

The intermittent treatment may be performed, for example, whenever a predetermined time of the nitrification treatment elapses, when the concentration of the nitrite nitrogen is equal to or lower than a predetermined value, or when the concentration of the nitrate nitrogen is equal to or higher than a predetermined value. For example, in the intermittent treatment, a time for holding the pH at a predetermined value may be 2 hours or more and 12 hours or less. The adjustment may be performed for 2 hours or more and 12 hours or less per day, and the pH may be adjusted to pH 7 or more and pH 8.2 or less, or not adjusted for the other time.

The water to be treated which is subjected to a nitrification treatment is preferably adjusted to a dissolved oxygen concentration set so that the ratio of the concentration of the ammoniacal nitrogen to the concentration of the nitrite nitrogen is 1:1 to 1:1.5. Normally, when the dissolved oxygen concentration is adjusted within a range of about 0.5 mg/L or more and 4.0 mg/L or less, the nitrification rate of the nitritation is in an appropriate range. When the concentration ratio is adjusted to an appropriate value, in the case of a one-pass type treatment, the anaerobic ammonium oxidation reaction efficiently proceeds, whereby a high nitrogen removal rate can be obtained.

The anaerobic ammonium oxidation treatment step is performed by stirring the water to be treated and adjusting the pH as necessary under an oxygen-free condition in the anaerobic ammonium oxidation reactor 6 holding the anaerobic ammonium oxidizing bacteria. The pH of the water to be treated is preferably pH 6.5 or higher and pH 9 or lower, and more preferably pH 7 or higher and pH 8.2 or lower. The water temperature of the water to be treated is preferably 10° C. or higher and 40° C. or lower, and more preferably 15° C. or higher and 37° C. or lower. The water to be treated may be preliminarily subjected to pH adjustment, an organic substance decomposition treatment, and a degassing treatment of reducing a dissolved oxygen concentration, and the like after the nitrification treatment step and before the anaerobic ammonium oxidation treatment step.

According to the above nitrogen treatment method, the load of the ammoniacal nitrogen in the nitrification treatment step is increased, and the treatment of adjusting the pH of the water to be treated is performed, whereby the free ammonia concentration can be increased with good responsiveness. Therefore, the activity of the nitrite oxidizing bacteria can be reliably suppressed without significantly reducing the activity of the ammonia oxidizing bacteria. Even if the ammoniacal nitrogen is converted to the nitrite nitrogen by the activity of the ammonia oxidizing bacteria, the nitrite nitrogen is less likely to be converted to the nitrate nitrogen, whereby the production of the nitrate nitrogen can be suppressed to stabilize the concentration of the nitrite nitrogen.

According to the above nitrogen treatment method, the concentration of the nitrite nitrogen is stabilized, whereby the treatment efficiency of the subsequent anaerobic ammonium oxidation is also improved to stably obtain a high nitrogen removal rate. The load of the ammoniacal nitrogen in the nitrification treatment step is increased, whereby a high-load operation with a high nitrogen removal rate can be provided. The treatment of adjusting the pH of the water to be treated can be performed at an appropriate time during the nitrification treatment, whereby the treatment is advantageous in that the treatment can be controlled depending on the concentration of ammoniacal nitrogen in raw water.

FIG. 2 is a schematic diagram showing another example of a wastewater treatment device used for a nitrogen treatment.

A nitrogen treatment method according to the present embodiment can also be conducted in a wastewater treatment device 200 as shown in FIG. 2. The wastewater treatment device 200 shown in FIG. 2 includes an ammonia oxidation tank 1, microbial sludge 2, an air diffuser 3, a pH adjusting device 4, a dissolved oxygen (DO) sensor 5, an anaerobic ammonium oxidation reactor 6, microbial sludge 7, and an inactivation device 8.

The wastewater treatment device 200 is a device which subjects wastewater containing a nitrogen component to a nitrogen treatment according to an anaerobic ammonium oxidation method, and is a two-tank device which performs nitritation and anaerobic ammonium oxidation in separate reactors. In the wastewater treatment device 200, in order to suppress the production of nitrate nitrogen, a treatment of applying an inactivating operation to microbial sludge can be performed during the operation of the ammonia oxidation tank 1. The configuration of the wastewater treatment device 200 is substantially the same as that of the wastewater treatment device 100 except that the inactivation device 8 is provided.

The inactivation device 8 is provided to apply an inactivating operation to the microbial sludge 2 transferred from the ammonia oxidation tank 1. At least a part of the microbial sludge 2 held in the ammonia oxidation tank 1 is transferred from the ammonia oxidation tank 1 to the inactivation device 8 to apply an inactivating operation to the microbial sludge 2 while a nitrification treatment is performed.

During the nitrification treatment in the ammonia oxidation tank 1, the inactivating operation sterilizes at least a part of ammonia oxidizing bacteria and nitrite oxidizing bacteria or causes bacteriostasis, but the growth rate of the ammonia oxidizing bacteria is higher than that of the nitrite oxidizing bacteria, whereby the ammonia oxidizing bacteria can predominantly grow after the inactivating operation is applied. Therefore, by applying the inactivating operation to at least a part of the microbial sludge 2, nitrite oxidizing activity can be suppressed while ammonia oxidizing activity is kept high.

The inactivating operation is an operation of sterilizing microorganisms or inhibiting the growth of the microorganisms, and means an operation of at least temporarily reducing the biological activity of a nitrification bacterial group contained in microbial sludge. Examples of the inactivating operation include an operation for bringing microbial sludge into contact with an acid, an alkali, an organic solvent, a bactericide, a hypertonic solution, an ammonia solution, or nitrous acid or the like, and an operation for subjecting the microbial sludge to heat sterilization, radiation sterilization, gaseous sterilization, and physical sterilization and the like.

Examples of the acid which can be used include hydrochloric acid, sulfuric acid, acetic acid, lactic acid, citric acid, and aqueous solutions thereof. Examples of the alkali which can be used include sodium hydrogen carbonate, sodium hydroxide, potassium hydroxide, calcium hydroxide, and aqueous solutions thereof.

Examples of the organic solvent which can be used include alcohols such as ethanol and isopropanol, ethers such as diethyl ether, aldehydes such as chloroform, phenols, benzenes such as benzene and toluene, esters such as ethyl acetate, hydrocarbons such as hexane, dimethylsulfoxide, acetone, acetonitrile.

Examples of the bactericide which can be used include a solution containing a metal such as silver, copper or mercury, ozone, hydrogen peroxide, potassium permanganate, hypochlorite, chloramine, or titanium oxide or the like. Examples of the hypertonic solution which may be used include a hypertonic solution containing sodium chloride or the like. Examples of the ammonia solution and the nitrous acid solution which may be used include a solution having a concentration higher than a 50% inhibitory concentration.

When microbial sludge is brought into contact with an acid, an alkali, an organic solvent, a bactericide, a hypertonic solution, an ammonia solution, or nitrous acid solution or the like, the inactivating operation can be performed by a method for supplying the solution to the inactivation device 8 and adding the solution to the water to be treated containing the microbial sludge 2 transferred from the ammonia oxidation tank 1 or a method for immersing the microbial sludge 2 withdrawn from the water to be treated in the ammonia oxidation tank 1 in the solution.

Examples of the heat sterilization include an operation of heat-treating the water to be treated transferred from the ammonia oxidation tank 1 with the microbial sludge 2 and the microbial sludge 2 withdrawn from the water to be treated in the ammonia oxidation tank 1. The inactivating operation performing the heat sterilization can be performed by providing the inactivation device 8 with a heat exchange type or a jacket type humidifying device or a steam heating device.

Examples of the radiation sterilization include an operation of irradiating the water to be treated transferred with the microbial sludge 2 from the ammonia oxidation tank 1, and the microbial sludge 2 withdrawn from the water to be treated in the ammonia oxidation tank 1 with UV beams, gamma beams, or electron beams or the like. The inactivating operation performing the radiation sterilization may be performed by providing the inactivation device 8 with a UV-beam irradiation device, gamma-beam irradiation device, or an electron-beam irradiation device or the like.

Examples of the gaseous sterilization include an operation of bringing a gas of ethylene oxide, hydrogen peroxide, or formaldehyde or the like into contact with the microbial sludge 2 withdrawn from the water to be treated in the ammonia oxidation tank 1. The inactivating operation performing the gaseous sterilization can be performed by providing the inactivation device 8 with a gas supply device for supplying a gas of ethylene oxide, hydrogen peroxide, or formaldehyde or the like.

Examples of the physical sterilization include an operation of applying an external force which just destroys cells of microorganisms onto the water to be treated transferred with the microbial sludge 2 from the ammonia oxidation tank 1 and the microbial sludge 2 withdrawn from the water to be treated in the ammonia oxidation tank 1. The inactivating operation performing the physical sterilization may be performed by providing the inactivation device 8 with a steam heating device, a dry heating device, a pressurizing device which applies a high pressure, a decompression device, a jet generator which provides an impact force to wastewater, a stirrer, a bubble generator which generates microbubbles, a centrifugal separator, a drier, a sonicator, or a high voltage generator which applies a high voltage to microorganisms, or the like.

However, the inactivating operation is not limited to these operations, and appropriate operations may be used as long as such operations may sterilize a nitrification bacterial group or cause bacteriostasis. For example, operations for extremely changing a growth environment of a nitrification bacterial group, performing sterilization filtration to a nitrification bacterial group, or exposing a nitrification bacterial group to chemical agents or a variety of inhibitors or the like may be used by adjusting their operation conditions. The inactivating operation may be performed by using one of these operations alone or combining a plurality of the operations.

The inactivation device 8 may be, for example, a device for applying an inactivating operation to the microbial sludge 2 transferred with the water to be treated from the ammonia oxidation tank 1, or a device for applying an inactivating operation to the microbial sludge 2 withdrawn from the water to be treated in the ammonia oxidation tank separately from the water to be treated. From the viewpoint of being able to reduce energy costs and chemical agents and the like involved in a treatment, a device for withdrawing the microbial sludge 2 from the water to be treated and treating the microbial sludge 2 is preferable.

As shown in FIG. 2, a nitrogen treatment device 200 may include a transfer path L10 for transferring the microbial sludge 2 from the ammonia oxidation tank 1 to the inactivation device 8, and a return path L20 for returning the microbial sludge 2 from the inactivation device 8 to the ammonia oxidation tank 1 between the ammonia oxidation tank 1 and the inactivation device 8.

The transfer path L10 and the return path L20 may be, for example, formed by a pipe and a hose or the like, and configured to withdraw immobilized microbial sludge 2, microbial sludge 2 which forms granules via self-granulation, and microbial sludge 2 which floats in water together with the water to be treated, from the ammonia oxidation tank 1 and transfer these materials. As a transfer pump, pumps including an airlift pump, a screw pump, a piston pump, and a hose pump and the like can be used. The return path L20 may transfer these materials using gravity or the like in addition to the transfer pump.

Alternatively, the transfer path L10 and the return path L20 may be configured to be a sieve-type container such as a strainer or a colander so as to withdraw the microbial sludge 2 from the water to be treated and transfer it, when the microbial sludge 2 is in a state of being inclusively immobilized in a carrier, being inclusively immobilized to the surface of the carrier, being adhesively immobilized to the carrier, or forming granules via self-granulation. The sieve-type container may be installed so that the container automatically moves between the ammonia oxidation tank 1 and the inactivation device 4.

Next, another example of the nitrogen treatment method according to the present embodiment will be specifically described with reference to the nitrogen treatment in the wastewater treatment device 200.

In the nitrogen treatment method, the load of the ammoniacal nitrogen in the nitrification treatment step is increased as compared with a conventional treatment, and a treatment of applying an inactivating operation to the microbial sludge is performed in the nitrification treatment of the ammonia oxidation tank 1, whereby the activity of the nitrite oxidizing bacteria is suppressed. The treatment of applying the inactivating operation to the microbial sludge may be performed instead of the treatment of adjusting the pH of the water to be treated or with the treatment of adjusting the pH of the water to be treated. From the viewpoint of surely suppressing the production of the nitrite nitrogen, it is preferable to perform both the treatment of applying the inactivating operation to the microbial sludge and the treatment of adjusting the pH of the water to be treated.

Generally, in the nitrification bacterial group, when a temperature of water is low, when concentrations of ammoniacal nitrogen and nitrite nitrogen are low, when a dissolved oxygen concentration is high, or when pH is low, the activity of nitrite oxidizing bacteria is dominant, and therefore, nitrite nitrogen produced by ammonia oxidizing bacteria is rapidly oxidized to nitrate nitrogen by nitrite oxidizing bacteria. Therefore, only by adjusting an aeration flow rate, a nitrogen load, a water temperature, pH, a retention time, or a free ammonia concentration or the like, nitrite nitrogen is consumed to easily produce nitrate nitrogen, which makes it difficult to suppress the amount of the nitrate nitrogen produced.

In contrast, in the nitrogen treatment method, the inactivating operation is applied to the microbial sludge 2 withdrawn from the ammonia oxidation tank 1, whereby the activity of ammonia oxidizing bacteria which oxidize ammoniacal nitrogen to produce nitrite nitrogen, and the activity of nitrite oxidizing bacteria which oxidize nitrite nitrogen to produce nitrate nitrogen are once reduced.

In an environment where the load of the ammoniacal nitrogen is high or the pH is high, the activity of the ammonia oxidizing bacteria is recovered faster than that of the nitrite oxidizing bacteria. Meanwhile, the activity of the nitrite oxidizing bacteria is recovered slower as the load of the ammoniacal nitrogen is increased or as the pH is increased. However, the nitrite oxidizing bacteria show a higher growth rate than that of the ammonia oxidizing bacteria, whereby the activity of the nitrite oxidizing bacteria is higher than that of the ammonia oxidizing bacteria after the inactivating operation is applied or after a certain time passes.

Therefore, instead of the treatment of adjusting the pH of the water to be treated, or with the treatment of adjusting the pH of the water to be treated, the treatment of applying an inactivating operation to the microbial sludge is performed, to produce a state where the activity of the ammonia oxidation reaction is relatively superior, whereby the production of the nitrate nitrogen can be suppressed.

The volume load of the ammoniacal nitrogen in the nitrification treatment step is a high load of 0.3 kg-N/m³·day or more and 5 kg-N/m³·day or less, as with the case where the pH is adjusted by the wastewater treatment device 100. The volume load is more preferably 1 kg-N/m³·day or more and 5 kg-N/m³·day or less.

When the microbial carrier is used in the ammonia oxidation tank 1, the carrier load of the ammoniacal nitrogen in the nitrification treatment step is a high load of 3 kg-N/m³-carrier·day or more and 100 kg-N/m³-carrier·day or less as with the case of performing the treatment of adjusting the pH in the wastewater treatment device 100. The carrier load is more preferably 40 kg-N/m³-carrier·day or more and 100 kg-N/m³-carrier·day or less.

The treatment of applying the inactivating operation to the microbial sludge may be performed by withdrawing a part of the microbial sludge 2 from the ammonia oxidation tank 1 to the inactivation device 8, or by withdrawing the entire microbial sludge 2 to the inactivation device 8. When the biomass of the microbial sludge 2 to which the inactivating operation is applied is increased, the nitrite oxidizing activity of the microbial sludge 2 is rapidly reduced, whereby the amount of the nitrate nitrogen produced can be early suppressed. Meanwhile, when the biomass is reduced, the ammonia oxidizing activity in the ammonia oxidation tank 1 is likely to be maintained. However, this makes it difficult to suppress the nitrite oxidizing activity of the microbial sludge 2, whereby the nitrite oxidizing activity is likely to be recovered after the inactivating operation.

The treatment of applying the inactivating operation to the microbial sludge may be continuously or intermittently performed during the nitrification treatment. The intermittent treatment may be performed, for example, whenever a predetermined time of the nitrification treatment elapses, when the concentration of the nitrite nitrogen is equal to or lower than a predetermined value, or when the concentration of the nitrate nitrogen is equal to or higher than a predetermined value. The treatment of applying the inactivating operation to the microbial sludge may be performed at an acclimatization stage before the nitrification treatment.

The treatment of applying the inactivating operation to the microbial sludge may be applied to sludge having an appropriate amount of biomass, of the microbial sludge held in the ammonia oxidation tank 1 depending on the nitrogen load, the amount of sludge, the amount of the nitrite nitrogen produced, and the amount of the nitrate nitrogen produced and the like in the ammonia oxidation tank 1. In the inactivating operation applied to the microbial sludge, the intensity of the action of sterilizing the microorganisms or causing bacteriostasis and the time interval applied to the microbial sludge are not particularly limited.

The amount of the nitrite nitrogen produced in the nitrification treatment step is preferably adjusted by one or more of adjustment of the biomass of the microbial sludge to which the inactivating operation is applied, adjustment of the intensity of the sterilizing action or bacteriostasis action in the inactivating operation, and adjustment of the time interval of the inactivating operation intermittently applied. According to one or more of these adjustments, the nitrite oxidizing activity of the microbial sludge can be appropriately controlled even if variations and the like which cannot be addressed only by controlling the dissolved oxygen concentration occur.

The inactivating operation is performed so that the nitrification bacterial group is not completely sterilized but sufficiently subjected to bacteriostasis. Intensities for reducing the activity of the nitrification bacterial group are different depending on the types and conditions of the operation, the biomass subjected to the inactivating treatment, and the treatment environment. Therefore, for the inactivating operation to be used, it is preferable to perform a preliminary test in advance, and preliminarily grasp the intensity for reducing the activity of the nitrification bacterial group.

The biomass of the microbial sludge 2 to which the inactivating operation is applied is preferably several tens percentages (%) or less to the total biomass held in the ammonia oxidation tank 1, and more preferably 10% or less or several percentages (%) to the total biomass. This is because the larger amount of the microbial sludge 2 to be withdrawn from the ammonia oxidation tank 1 prevents the oxidation of the ammoniacal nitrogen from proceeding. this does not apply to a case where the inactivating operation is applied in the ammonia oxidation tank 1 without withdrawing the microbial sludge 2 from the ammonia oxidation tank 1. The biomass of the microbial sludge 2 to which the inactivating operation is applied may be the same or different among the respective inactivating operations.

The adjustment of the intensity of the sterilizing action or bacteriostasis action in the inactivating operation depends on the type of the operation, but the adjustment can be performed, for example, by changing various physical quantities or industrial quantities which correlate with the number of microorganisms to be sterilized or subjected to bacteriostasis. For example, the intensity can be adjusted by changing time, concentration, pH, and temperature and the like when the microbial sludge is brought into contact with various solutions, heat quantity and the like in the case of heat sterilization, dose and the like in the case of radiation sterilization, time and concentration and the like in the case of gaseous sterilization, and time, pressure, atmospheric pressure, flow velocity, centrifugal force, impact force, voltage, sonic frequency, and distance, area, and density and the like to be operated in the case of physical sterilization.

The time interval of the inactivating operation can be adjusted by changing a pause time between the inactivating operations when the treatment of applying the inactivating operation is intermittently performed. When the inactivating operation is applied to the microbial sludge, the ammonia oxidizing bacteria and the nitrite oxidizing bacteria are sterilized or subjected to bacteriostasis, but when the load of the ammoniacal nitrogen is increased, the growth rate of the ammonia oxidizing bacteria is faster than that of the nitrite oxidizing bacteria. Therefore, the ammonia oxidizing bacteria can be predominantly grown by changing the time interval of the inactivating operation which is intermittently repeated.

For example, when, under a condition where the biomass of the microbial sludge 2 to which the inactivating operation is applied is constant, the time interval of the inactivating operation is shortened, and the frequency of the inactivating operation is increased, the reduction of the activities of the ammonia oxidizing bacteria and nitrite oxidizing bacteria is accelerated. At this time, in the ammonia oxidation tank 1, the load of the ammoniacal nitrogen is increased, and the growth rate of the ammonia oxidizing bacteria is faster than that of the nitrite oxidizing bacteria, whereby the activity of the ammonia oxidizing bacteria is likely to be relatively recovered, which provides an increased ratio of the nitrite nitrogen.

Meanwhile, when, under a condition where the biomass of the microbial sludge 2 to which the inactivating operation is applied is constant, the time interval of the inactivating operation is lengthened, and the frequency of the inactivating operation is reduced, the reduction of the activities of the ammonia oxidizing bacteria and the nitrite oxidizing bacteria is late. At this time, in the ammonia oxidation tank 1, a difference between the activity of the ammonia oxidizing bacteria and the activity of the nitrite oxidizing bacteria is less likely to occur, whereby the nitrite nitrogen is consumed to provide an increased ratio of the nitrate nitrogen.

The time interval of the inactivating operation is not particularly limited, but from the viewpoint of cost for transferring the microbial sludge 2 and from the viewpoint of ensuring a time for restoring the activity, the time interval is preferably once to several times per day, or once per several days. However, this does not apply to a case where the inactivating operation is applied in the ammonia oxidation tank 1 without withdrawing the microbial sludge 2 from the ammonia oxidation tank 1. The ratio of the ammoniacal nitrogen to the nitrite nitrogen is more preferably adjusted by a combination of adjustment of the biomass of the microbial sludge to which the inactivating operation is applied, with adjustment of the intensity of the sterilizing action or bacteriostasis action in the inactivating operation or adjustment of the time interval of the inactivating operation to be intermittently applied.

When the inactivating operation is an operation of applying heat sterilization to the microbial sludge, a heating temperature is preferably 30° C. or higher and 90° C. or lower, and from the viewpoint of performing sufficient inactivation while avoiding complete sterilization, the heating temperature is more preferably 40° C. or higher and 70° C. or lower. When the microbial sludge is in a state of being inclusively immobilized on the carrier, the temperature is preferably 50° C. or higher and 70° C. or lower. A heating time is preferably 1 hour or more from the viewpoint of performing sufficient inactivation, and is preferably 2 weeks or less from the viewpoint of reducing wasteful energy.

The water to be treated in the nitrification treatment step is preferably adjusted to a dissolved oxygen concentration set so that a ratio of a concentration of ammoniacal nitrogen to a concentration of nitrite nitrogen is 1:1 to 1:1.5 as with the case of performing the treatment of adjusting the pH in the wastewater treatment device 100. The water temperature of the water to be treated in the nitrification treatment step is generally 10° C. or higher and 40° C. or lower.

The anaerobic ammonium oxidation treatment step is performed by stirring the water to be treated and adjusting the pH as necessary under an oxygen-free condition as with the case of performing the treatment of adjusting the pH in the wastewater treatment device 100. The water to be treated may be preliminarily subjected to pH adjustment, an organic substance decomposition treatment, and a treatment of reducing a dissolved oxygen concentration, and the like after the nitrification treatment step and before the anaerobic ammonium oxidation treatment step.

According to the above nitrogen treatment method, the load of the ammoniacal nitrogen in the nitrification treatment step is increased, and the treatment of applying the inactivating operation to the microbial sludge is performed, whereby the activity of the nitrite oxidizing bacteria can be suppressed without significantly reducing the activity of the ammonia oxidizing bacteria. Even if the ammoniacal nitrogen is converted to the nitrite nitrogen by the activity of the ammonia oxidizing bacteria, the nitrite nitrogen is less likely to be converted to the nitrate nitrogen, whereby the production of the nitrate nitrogen can be suppressed to stabilize the concentration of the nitrite nitrogen. Since the conditions for the inactivating operation can be appropriately set by performing a preliminary test in advance, the responsiveness and accuracy of control can also be improved as compared with the method for adjusting only the aeration flow rate.

As mentioned hereinbefore, the embodiments of the present invention have been described. However, the present invention is not limited to the above embodiments, and a variety of modifications may be available without departing from the scope of the present invention. For example, a part of the components of the embodiments may be replaced by other components without departing from the scope of the present invention. Some of the components may be added to the embodiments, and a part of the components of the embodiments may be omitted.

For example, in the wastewater treatment devices 100 and 200, the ammonia oxidation tank 1 is described as a one-pass tank which is configured to subject the entire amount of the water to be treated to nitritation. However, the ammonia oxidation tank 1 may be a by-pass tank. That is, a part of the water to be treated may be introduced into the ammonia oxidation tank 1 to oxidize the entire amount of the ammoniacal nitrogen to produce the nitrite nitrogen, while the remaining part of the water to be treated is diverted so as not to be subjected to nitritation, and joins the anaerobic ammonium oxidation reactor 6.

Alternatively, the wastewater treatment devices 100 and 200 may be used as a single tank in which nitritation and anaerobic ammonium oxidation are performed as a single tank. That is, in the single-tank anaerobic ammonium oxidation method, the load of the ammoniacal nitrogen is increased, and furthermore, at least one of the treatment of adjusting the pH of the water to be treated, and the treatment of applying the inactivating operation to the microbial sludge may be performed.

The wastewater treatment devices 100 and 200 may include a circulation line for returning the treated water treated in the anaerobic ammonium oxidation reactor 6 to the ammonia oxidation tank 1. When the concentration of the nitrite nitrogen in the ammonia oxidation tank 1 largely exceeds 1000 mg/L, the activity of the ammonia oxidizing bacteria by the nitrite nitrogen is continuously inhibited, so that the activity of the ammonia oxidizing bacteria may not be recovered. In such a case, a part of the treated water is returned through the circulation line, whereby the concentration of the nitrite nitrogen in the ammonia oxidation tank 1 can be decreased.

In the wastewater treatment devices 100 and 200, an adjustment tank configured to adjust the water quality and water flow rate of the wastewater, a bioreactor configured to biologically decompose organic substances contained in the wastewater, or a pre-denitrification tank configured to denitrify the nitrate nitrogen contained in the wastewater in advance may be provided on the upstream side of the ammonia oxidation tank 1. A post-denitrification tank or the like configured to denitrify the nitrate nitrogen produced in the anaerobic ammonium oxidation reaction may be provided on the downstream side of the ammonia oxidation tank 1. Examples of the bioreactor include a treating tank configured to decompose organic substances by, for example, an activated sludge method, a sprinkling filter method, an aerobic filter method, a rotating biological contact method, a membrane separation bioreactor method, an anaerobic filter method, and an anaerobic granule sludge method and the like.

The wastewater treatment device 200 may manually transfer the microbial sludge 2 without including the transfer path L10 and the return path L20. The wastewater treatment device 200 includes the pH adjusting device 4, but it may be a device which performs only the treatment of applying the inactivating operation to the microbial sludge without including the pH adjusting device. The wastewater treatment device 200 may be a device which includes the inactivation device 8 provided in the treatment tank, and treats the microbial sludge without transferring it from the treatment tank.

### EXAMPLES

Hereinafter, the present invention will be described in more detail with reference to Examples, but the technical scope of the present invention is not limited thereto.

### Example 1

First, an inclusively immobilized carrier was prepared, in which microbial sludge as a mixture of ammonia oxidizing bacteria (AOB) and nitrite oxidizing bacteria (NOB) was immobilized. The inclusively immobilized carrier was subjected to a heat treatment (heat sterilization) as an inactivating operation. The inclusively immobilized carrier was introduced into a reactor having a volume of 1 L so that the volume of the inclusively immobilized carrier was 0.1 L, and the reactor was placed in a thermostat bath kept at 20° C. Raw water having an ammoniacal nitrogen concentration of about 40 mg-N/L was introduced into the reactor so that a hydraulic retention time was 4 hours, to start a nitrogen treatment. Water to be treated in the reactor was aerated with a blower, and the pH of the water to be treated was adjusted to pH 8.5 by adding an alkaline pH adjusting agent.

After the nitrogen treatment was started, the flow rate of the raw water was increased every few days to several weeks with the increase of the oxidation rate of ammoniacal nitrogen, to gradually shorten the hydrologic retention time. The hydrologic retention time was finally reduced to 1 hour. The nitrogen treatment was continued while the pH of the water to be treated was continuously adjusted to pH 8.5 in a state where the volume load of the ammoniacal nitrogen was set to a high load of about 1 kg-N/m³·day. During the nitrogen treatment, the dissolved oxygen concentration of the water to be treated was adjusted to about 2 to 3 mg/L, and the ratio of the concentration of the ammoniacal nitrogen to the concentration of nitrite nitrogen was controlled to 1:1 to 1:1.5.

When the nitrogen treatment reached a steady state, the concentration of the ammoniacal nitrogen was 18 mg/L; the concentration of the nitrite nitrogen was 24 mg/L; and the concentration of nitrate nitrogen was 1.2 mg/L.

### Comparative Example 1

First, an inclusively immobilized carrier was prepared, in which microbial sludge as a mixture of ammonia oxidizing bacteria (AOB) and nitrite oxidizing bacteria (NOB) was immobilized. The inclusively immobilized carrier was subjected to a heat treatment (heat sterilization) as an inactivating operation. The inclusively immobilized carrier was introduced into a reactor having a volume of 1 L so that the volume of the inclusively immobilized carrier was 0.1 L, and the reactor was placed in a thermostat bath kept at 20° C. Raw water having an ammoniacal nitrogen concentration of about 40 mg-N/L was introduced into the reactor so that a hydraulic retention time was 4 hours, to start a nitrogen treatment. Water to be treated in the reactor was aerated with a blower, and the pH of the water to be treated was adjusted to pH 8.5 by adding an alkaline pH adjusting agent.

The nitrogen treatment was continued while the pH of the water to be treated was continuously adjusted to pH 8.5 in a state where the volume load of the ammoniacal nitrogen was set to about 0.24 kg-N/m³·day. During the nitrogen treatment, the dissolved oxygen concentration of the water to be treated was adjusted to about 0.5 to 1 mg/L, and the ratio of the concentration of the ammoniacal nitrogen to the concentration of nitrite nitrogen was set to 1:1 to 1:1.5.

When the nitrogen treatment reached a steady state, the concentration of the ammoniacal nitrogen was 5 to 20 mg/L; the concentration of the nitrite nitrogen was 5 to 18 mg/L; and the concentration of nitrate nitrogen was 5 to 31 mg/L.

As shown in the results of Example 1 and Comparative Example 1, even if the treatment of adjusting the pH of the water to be treated is performed during the nitrification treatment, the amount of the nitrate nitrogen produced, and the stability and controllability of a nitrification treatment are different when the load of the ammoniacal nitrogen is different. When the load of the ammoniacal nitrogen is increased as in Example 1, the concentration of the nitrate nitrogen is largely reduced by the treatment of adjusting the pH of the water to be treated. Meanwhile, as in Comparative Example 1, when the load of the ammoniacal nitrogen was normal, the ratio of the concentration of the ammoniacal nitrogen to the concentration of the nitrite nitrogen largely fluctuated, which made it extremely difficult to control the nitrification treatment.

Therefore, it can be said that the production of the nitrate nitrogen can be stably suppressed by increasing the load of the ammoniacal nitrogen in the nitrification treatment step, and performing the treatment of adjusting the pH of the water to be treated. Under such treatment conditions, the nitritation treatment is stabilized, whereby the ratio of the concentration of the ammoniacal nitrogen to the concentration of the nitrite nitrogen can be said to be easily controlled to a predetermined value.

### Example 2

First, an inclusively immobilized carrier was prepared, in which microbial sludge as a mixture of ammonia oxidizing bacteria (AOB) and nitrite oxidizing bacteria (NOB) was immobilized. The inclusively immobilized carrier was subjected to a heat treatment (heat sterilization) as an inactivating operation. The inclusively immobilized carrier was introduced into a reactor having a volume of 1 L so that the volume of the inclusively immobilized carrier was 0.1 L, and the reactor was placed in a thermostat bath kept at 20° C. Raw water having an ammoniacal nitrogen concentration of about 100 mg-N/L was introduced into the reactor so that a hydraulic retention time was 6 hours, to start a nitrogen treatment. Water to be treated in the reactor was aerated with a blower, and the pH of the water to be treated was maintained at around pH 7 only by aeration.

After the nitrogen treatment was started, the amount of the carrier introduced was gradually reduced every few days to several weeks with the increase of the oxidation rate of the ammoniacal nitrogen. The amount of the carrier introduced was finally reduced to 0.01 L. First, the carrier load of the ammoniacal nitrogen was set to a high load of about 40 kg-N/m³-carrier·day, and the nitrogen treatment was performed until the pH of the water to be treated was maintained at around pH 7 by only aeration, and the nitrogen treatment was in a steady state. Then, the nitrogen treatment was continued until the pH of the water to be treated was continuously adjusted to pH 8.5 and the nitrogen treatment was in a steady state while the carrier load of the ammoniacal nitrogen was kept at a high load of about 40 kg-N/m³-carrier·day. Then, the pH adjustment was stopped when the oxidation rate of nitrite nitrogen was constant. The pH of the water to be treated was maintained at around pH 7 only by aeration, and the nitrogen treatment was continued until the nitrogen treatment was in a steady state. During the nitrogen treatment, the dissolved oxygen concentration of the water to be treated was adjusted to about 8 mg/L so that the ratio of the concentration of the ammoniacal nitrogen to the concentration of nitrite nitrogen was 1:1 to 1:1.5.

Table 1 shows the concentration of the ammoniacal nitrogen, the concentration of the nitrite nitrogen, and the concentration of the nitrate nitrogen when the nitrogen treatment is in a steady state before the pH adjustment is started, while the pH is adjusted, and after the pH adjustment is stopped.

TABLE 1

| | | NH₄—N | NO₂—N | NO₃—N |
|---|---|---|---|---|
| | TREATMENT CONTENTS | [mg/L] | [mg/L] | [mg/L] |
| START OF HIGH-LOAD OPERATION | HIGH LOAD (pH ≈ 7) | 42 | 49 | 15 |
| TO START OF pH ADJUSTMENT | | | | |
| START OF pH ADJUSTMENT | HIGH LOAD + pH | 46 | 54 | 3 |
| TO END OF pH ADJUSTMENT | ADJUSTMENT (pH ≈ 8.5) | | | |
| END OF pH ADJUSTMENT | HIGH LOAD (pH ≈ 7) | 34 | 56 | 12 |
| TO END OF HIGH-LOAD OPERATION | | | | |

As shown in the results of Example 2, when the load of the ammoniacal nitrogen is increased, fluctuations in the concentrations of the ammoniacal nitrogen and nitrite nitrogen are smaller, but the amount of the nitrate nitrogen produced is increased. When the load of the ammoniacal nitrogen is increased, and the treatment of adjusting the pH of the water to be treated is performed, the production of the nitrate nitrogen is largely suppressed. However, the concentration of the nitrate nitrogen can be confirmed to be increased again when the pH adjustment is stopped.

Therefore, it can be said that, by simply increasing the load of the ammoniacal nitrogen in the nitrification treatment step, the production of the nitrate nitrogen cannot be sufficiently suppressed even if the dissolved oxygen concentration is controlled. From the viewpoint of achieving a high nitrogen removal rate, a method which the high load of the ammoniacal nitrogen is combined with the treatment of adjusting the pH of the water to be treated can be said to be advantageous in that the production of the nitrate nitrogen can be suppressed while the nitrification rate is maintained.

### Example 3

First, an inclusively immobilized carrier was prepared, in which microbial sludge as a mixture of ammonia oxidizing bacteria (AOB) and nitrite oxidizing bacteria (NOB) was immobilized. The inclusively immobilized carrier was subjected to a heat treatment (heat sterilization) as an inactivating operation. The inclusively immobilized carrier was introduced into a reactor having a volume of 1 L so that the volume of the inclusively immobilized carrier was 0.1 L, and the reactor was placed in a thermostat bath kept at 20° C. Raw water having an ammoniacal nitrogen concentration of about 40 mg-N/L was introduced into the reactor so that a hydraulic retention time was 1 hour, to start a nitrogen treatment. Water to be treated in the reactor was aerated with a blower, and the pH of the water to be treated was not adjusted.

The nitrogen treatment was continued without adjusting the pH of the water to be treated in a state where the volume load of the ammoniacal nitrogen was set to about 1 kg-N/m³·day, and the carrier load was set to about 2.5 kg-N/m³·carrier·day. During the nitrogen treatment, the dissolved oxygen concentration of the water to be treated was adjusted to about 2 to 3 mg/L so that the ratio of the concentration of the ammoniacal nitrogen to the concentration of nitrite nitrogen was 1:1 to 1:1.5. During the nitrogen treatment, a heat treatment (heat sterilization) as an inactivating operation was intermittently performed.

When the nitrogen treatment reached a steady state, the concentration of the ammoniacal nitrogen was 18 mg/L; the concentration of the nitrite nitrogen was 23 mg/L; and the concentration of nitrate nitrogen was 2.3 mg/L.

### Comparative Example 2

First, an inclusively immobilized carrier was prepared, in which microbial sludge as a mixture of ammonia oxidizing bacteria (AOB) and nitrite oxidizing bacteria (NOB) was immobilized. The inclusively immobilized carrier was subjected to a heat treatment (heat sterilization) as an inactivating operation. The inclusively immobilized carrier was introduced into a reactor having a volume of 1 L so that the volume of the inclusively immobilized carrier was 0.1 L, and the reactor was placed in a thermostat bath kept at 20° C. Raw water having an ammoniacal nitrogen concentration of about 40 mg-N/L was introduced into the reactor so that a hydraulic retention time was 4 hours, to start a nitrogen treatment. Water to be treated in the reactor was aerated with a blower, and the pH of the water to be treated was not adjusted.

The nitrogen treatment was continued without adjusting the pH of the water to be treated in a state where the volume load of the ammoniacal nitrogen was set to about 0.24 kg-N/m³·day, and the carrier load was set to about 0.96 kg-N/m³·carrier·day. During the nitrogen treatment, the dissolved oxygen concentration of the water to be treated was adjusted to about 0.5 to 1 mg/L, and the ratio of the concentration of the ammoniacal nitrogen to the concentration of nitrite nitrogen was set to 1:1 to 1:1.5. During the nitrogen treatment, a heat treatment (heat sterilization) as an inactivating operation was intermittently performed.

When the nitrogen treatment reached a steady state, the concentration of the ammoniacal nitrogen was 1 to 34 mg/L; the concentration of the nitrite nitrogen was 7 to 23 mg/L; and the concentration of nitrate nitrogen was 4 to 19 mg/L.

As shown in the results of Example 3 and Comparative Example 2, the amount of the nitrate nitrogen produced, and the stability and controllability of the nitrification treatment are different when the load of the ammoniacal nitrogen is different if the inactivating operation is applied to the microbial sludge during the nitrification treatment. When the load of the ammoniacal nitrogen is increased as in Example 3, the concentration of the nitrate nitrogen is largely reduced by the treatment of applying the inactivating operation to the microbial sludge. Meanwhile, as in Comparative Example 2, when the load of the ammoniacal nitrogen was normal, the ratio of the concentration of the ammoniacal nitrogen to the concentration of the nitrite nitrogen largely fluctuated, which made it extremely difficult to control the nitrification treatment.

Therefore, it can be said that the production of the nitrate nitrogen can be stably suppressed by increasing the load of the ammoniacal nitrogen in the nitrification treatment step, and performing the treatment of applying the inactivating operation to the microbial sludge. Under such treatment conditions, the nitritation treatment is stabilized, whereby the ratio of the concentration of the ammoniacal nitrogen to the concentration of the nitrite nitrogen can be said to be easily controlled to a predetermined value.

### REFERENCE SIGNS LIST

1 ammonia oxidation tank
2 microbial sludge
3 air diffuser
4 pH adjusting device
5 dissolved oxygen sensor
6 anaerobic ammonium oxidation reactor
7 microbial sludge
8 inactivation device
100 wastewater treatment device
200 wastewater treatment device

1. A nitrogen treatment method for biologically treating a nitrogen component contained in wastewater,
the method comprising a nitrification treatment step of producing nitrite nitrogen by oxidizing ammoniacal nitrogen contained in water to be treated, using microbial sludge,
wherein:
a volume load of the ammoniacal nitrogen in the nitrification treatment step is set to a high load of 0.3 kg-N/m³·day or more and 5 kg-N/m³·day or less; and
in the nitrification treatment step, at least one of a treatment of adjusting a pH of the water to be treated to pH 8 or more and pH 10 or less and a treatment of applying an inactivating operation for sterilizing microorganisms or causing bacteriostasis to the microbial sludge is performed.

2. A nitrogen treatment method for biologically treating a nitrogen component contained in wastewater,
the method comprising a nitrification treatment step of producing nitrite nitrogen by oxidizing ammoniacal nitrogen contained in water to be treated, using microbial sludge,
wherein:
the microbial sludge is immobilized;
a carrier load of the ammoniacal nitrogen in the nitrification treatment step is set to a high load of 3 kg-N/m³-carrier·day or more and 100 kg-N/m³-carrier·day or less; and
in the nitrification treatment step, at least one of a treatment of adjusting a pH of the water to be treated to pH 8 or more and pH 10 or less and a treatment of applying an inactivating operation for sterilizing microorganisms or causing bacteriostasis to the microbial sludge is performed.

3. The nitrogen treatment method according to claim 1, wherein the microbial sludge is in a state of being inclusively immobilized in a carrier, being inclusively immobilized on a surface of the carrier, being adhesively immobilized to the carrier, or forming granules via self-granulation.

4. The nitrogen treatment method according to claim 1, wherein the treatment of adjusting the pH is continuously performed during the treatment of the water to be treated.

5. The nitrogen treatment method according to claim 1, wherein the treatment of adjusting the pH is intermittently performed during the treatment of the water to be treated.

6. The nitrogen treatment method according to claim 1,
wherein:
in the nitrification treatment step, at least the treatment of adjusting the pH is performed; and the treatment of adjusting the pH is a treatment of adjusting the pH of the water to be treated to pH 8.5 or more and pH 9.5 or less.

7. The nitrogen treatment method according to claim 1, wherein the inactivating operation is an operation of bringing the microbial sludge into contact with an acid, an alkali, an organic solvent, a bactericide, a hypertonic solution, an ammonia solution, or a nitrous acid solution, or subjecting the microbial sludge to heat sterilization, radiation sterilization, gaseous sterilization, or physical sterilization.

8. The nitrogen treatment method according to claim 1,
wherein:
in the nitrification treatment step, at least the treatment of applying an inactivating operation is performed;
a production amount of the nitrite nitrogen is adjusted by one or more of adjustment of a biological amount of the microbial sludge to which the inactivating operation is applied, adjustment of intensity of a sterilizing action or bacteriostasis action in the inactivating operation, and adjustment of a time interval of the inactivating operation intermittently performed.

9. The nitrogen treatment method according to claim 1, wherein:
the inactivating operation is an operation of subjecting the microbial sludge to heat sterilization; and
a heating temperature is 30° C. or higher and 90° C. or lower.

10. The nitrogen treatment method according to claim 1,
wherein:
the microbial sludge is in a state of being inclusively immobilized in a carrier, or inclusively immobilized on a surface of the carrier;
the inactivating operation is an operation of subjecting the microbial sludge to heat sterilization; and
a heating temperature is 50° C. or higher and 70° C. or lower.

11. The nitrogen treatment method according to claim 1,
wherein:
the inactivating operation is an operation of subjecting the microbial sludge to heat sterilization; and
a heating time is 1 hour or more and 2 weeks or less.

12. The nitrogen treatment method according to claim 1, wherein, in the nitrification treatment step, the water to be treated is adjusted to a dissolved oxygen concentration set so that a ratio of a concentration of ammoniacal nitrogen to a concentration of nitrite nitrogen is 1:1 to 1:1.5.

13. The nitrogen treatment method according to claim 1, wherein a total nitrogen concentration in the water to be treated which is treated in the nitrification treatment step is 10 mg/L or more and 150 mg/L or less.
